(19) United States
(12) Patent Application Publication
(10) Pub. No.: US 2025/0001839 A1
(43) Pub. Date: Jan. 2, 2025

(54) UTV INJECTED GLASS WINDSHIELD FRAME AND LATCHING SYSTEM

(71) Applicant: Sportech, LLC, Elk River, MN (US)

(72) Inventor: Cory McWhorter, Big Lake, MN (US)

(73) Assignee: Sportech, LLC, Elk River, MN (US)

(21) Appl. No.: 18/755,131

(22) Filed: Jun. 26, 2024

Related U.S. Application Data
(60) Provisional application No. 63/523,791, filed on Jun. 28, 2023.

(51) Int. Cl. B60J 1/04; B60J 1/00

(52) U.S. Cl. CPC B60J 1/04; B60J 1/004

(57) ABSTRACT

A windshield mounting assembly for mounting a windshield on a roll-over protection system (ROPS) of a utility terrain vehicle consists of a four-piece frame for holding the windshield. A top frame member pivotally attaches to a top portion of the ROPS, allowing the windshield to move between a closed position and an open position. A latch attached to a bottom windshield frame member has a free end biased towards a mount connected to a dashboard of the utility terrain vehicle. The mount includes a first location and a second location spaced from the first location where the free end of the latch can engage the mount to secure the windshield in the closed or the open position.

### CROSS REFERENCE TO RELATED APPLICATIONS

This application claims the benefit of U.S. Provisional Application No. 63/523,791, filed Jun. 28, 2023.

### SUMMARY

A windshield mounting assembly for mounting to roll-over protection frame of a utility terrain vehicle (UTV) is disclosed. The windshield mounting assembly includes windshield held in a frame having top, side and bottom frame members. The top frame member is pivotally connectable to a top portion of the roll-over protection frame of the UTV. The windshield is moveable between a closed first position and an open second position. A mount is attached to a dashboard of the UTV adjacent to the bottom frame member. A latch has a first end connected to the bottom frame member and a second end spaced from the bottom frame member. The first end of the latch is biased towards the mount. The first end of the latch is engageable with a first position on the mount when the windshield is in the closed first position, and the first end of the latch is engageable with a second position on the mount when the windshield is in the open second position.

### BRIEF DESCRIPTION OF THE DRAWINGS

FIG. 1 is a front perspective view of a first embodiment of a windshield mounting assembly mounted to a roll-over protection system for a utility terrain vehicle.

FIG. 2A is a partial perspective view of a left half of the windshield mounting assembly of FIG. 1.

FIG. 2B is a partial view of a top left corner of a frame of the windshield mounting assembly of FIG. 2A.

FIG. 3A is an enlarged portion of the bottom left corner of the frame of the windshield mounting assembly of FIG. 2A.

FIG. 3B is a perspective view of an enlarged portion of the bottom left corner of the frame of the windshield mounting assembly of FIG. 3A with a corner portion of the windshield partially shown in phantom.

FIG. 4 is a front perspective view of a front perspective view of a second embodiment of a windshield mounting assembly for a utility terrain vehicle.

FIG. 5 is an exploded front perspective view of the windshield mounting assembly of FIG. 4.

FIG. 6 is a front perspective view of a top frame member of the windshield mounting assembly of FIG. 4

FIG. 7 is cross-sectional view of the top frame member of FIG. 6.

FIG. 8 is an exploded rear perspective view of the top left corner of the top frame member and the side frame member of the windshield mounting assembly of FIG. 4.

FIG. 9 is a rear perspective view of a top portion of the left side frame member of the windshield mounting assembly.

FIG. 10 is a rear perspective view of a bottom portion of the left side frame member of the windshield mounting assembly.

FIG. 11 is a rear view of the top left corner of the windshield mounting assembly of FIG. 4 showing the connection of top frame member with the side frame member.

FIG. 12 is a rear perspective view of the side frame member of the windshield mounting assembly.

FIG. 13 is a bottom perspective view of the windshield mounting assembly of FIG. 4.

FIG. 14 is a front perspective view of a front perspective view of a third embodiment of a windshield mounting assembly for a utility terrain vehicle.

FIG. 15 is a top perspective view of a first latching system for the windshield mounting assembly of FIG. 14.

FIG. 15A is a side view of the latching system of FIG. 15.

FIG. 15B is a rear perspective view of a portion of bottom windshield frame member and latch of the latching system.

FIG. 15C is an exploded view of the bottom windshield frame member and latch of FIG. 15B.

FIG. 16 is as a top perspective view of the latching system with the latch holding a windshield in an open position.

FIG. 16A is a side view of the latching system with the latch holding a windshield in an open position.

FIGS. 17A-17D are perspective views of the operation of latching system to move a windshield between a closed and an open position.

FIG. 18 is a second latching system for a windshield mounting assembly.

FIG. 19 is a rear perspective exploded view of the latching system of FIG. 18.

FIG. 20 is a rear elevational view of the latching system of FIG. 18.

FIG. 21 is a rear perspective view of the latching system of FIG. 18 showing an attachment of the latch to the bottom windshield frame member.

FIG. 22 is a rear perspective cross-sectional view of the latching system of FIG. 18.

FIG. 23 is a rear perspective view of a lower corner of a windshield frame showing a bottom windshield frame member attachment to a side windshield frame member.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

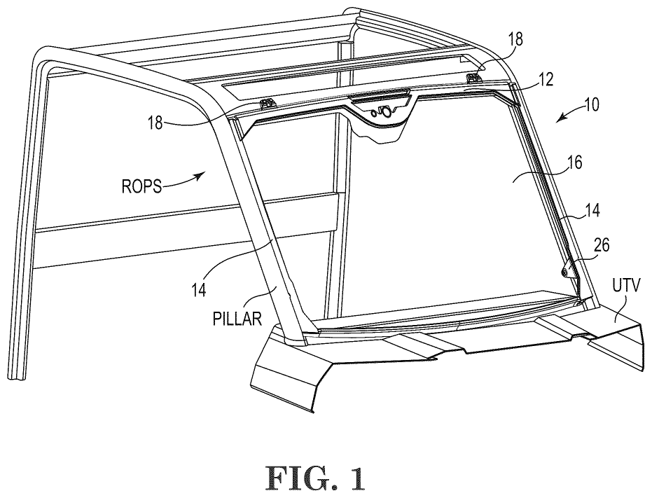

FIG. 1 shows a windshield mounting assembly 10 for utility terrain vehicles (UTVs) that have a roll-over protection system (ROPS) comprised of a frame that mounts to the UTV above the operator. One example of the windshield mounting assembly 10 includes a three-piece frame, with a top frame member 12 and two side frame members 14. Frame members 12 and 14 are made from plastic (e.g., glass filled Nylon, polypropylene, abs, polyethylene, or acrylonitrile styrene acrylate (ASA)) or metal, such as aluminum, and are each formed with a channel sized to receive edge portions of a glass windshield 16, as will be described further herein. In one embodiment, the top frame member 12 is connected to a front transverse beam of the ROPS by hinges 18, and two side frame members 14 that are reversibly connected to the top frame member 12. In the embodiment shown, each hinge 18 is formed from plastic or metal, such as nylon or aluminum, and in one embodiment is integrally attached to the top frame member 12. The portion of hinges 18 that connect to the top frame member 12 form a living hinge that allows flexing of the top frame member relative to the ROPS.

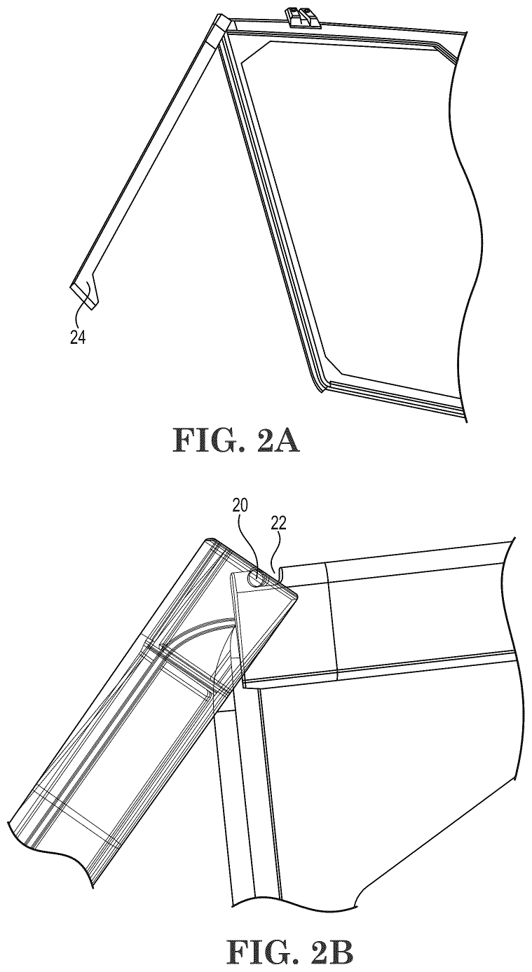

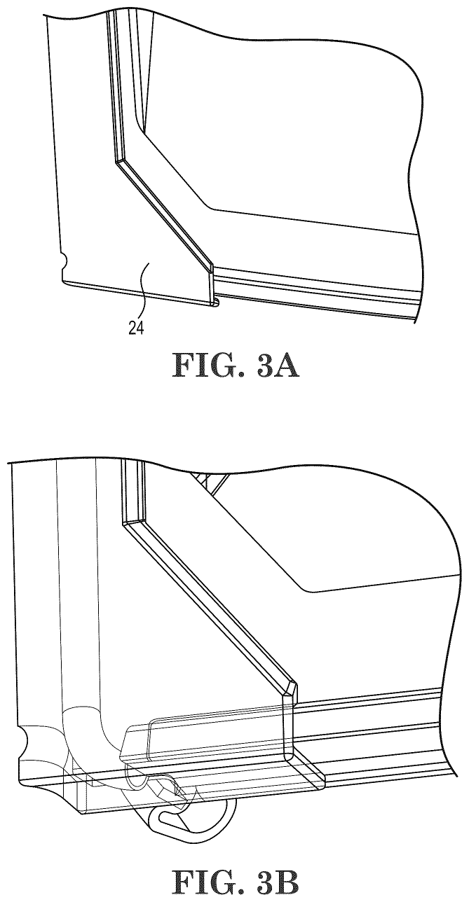

As shown in FIGS. 2A and 2B, in one embodiment the connection of side frame members 14 to top frame member 12 is made by a lift off hinge consisting of a post 20 on each side frame member that fits into a recess 22 formed in the top surface of the top frame member. In one embodiment, recess 22 has a length that is greater than a width of post 20. This connection allows assembly of the windshield support frame without additional hardware or tools. The top and side frame members 12 and 14 each have a channel that receives the windshield. The channels are sized to be greater than the outer dimensions of the windshield to allow the windshield to float (i.e., move) within the channel which absorbs tolerance variations for assembly to UTVs and reduces stress on the windshield when the UTV is jostled, such as on rugged terrain. Each side frame member further has a short transverse frame extension 24 at the lower end of the side frame member to support a portion of the lower edge of the windshield without the need for a full-length bottom frame member (FIGS. 2A, 3A and 3B). The side frame members are secured to a respective front pillar of the ROPS by a removable mount 26 (FIG. 1).

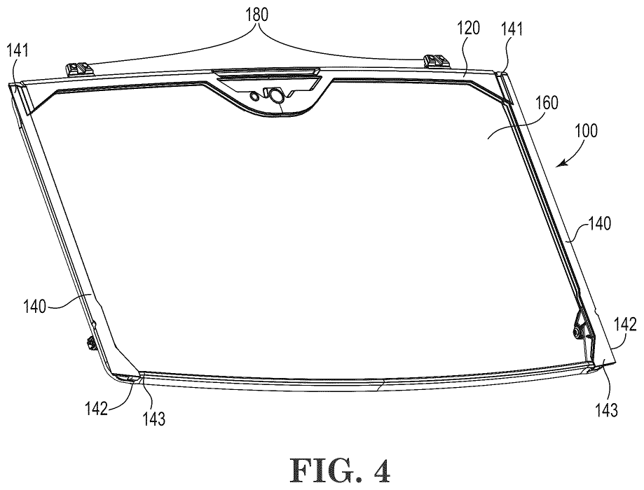

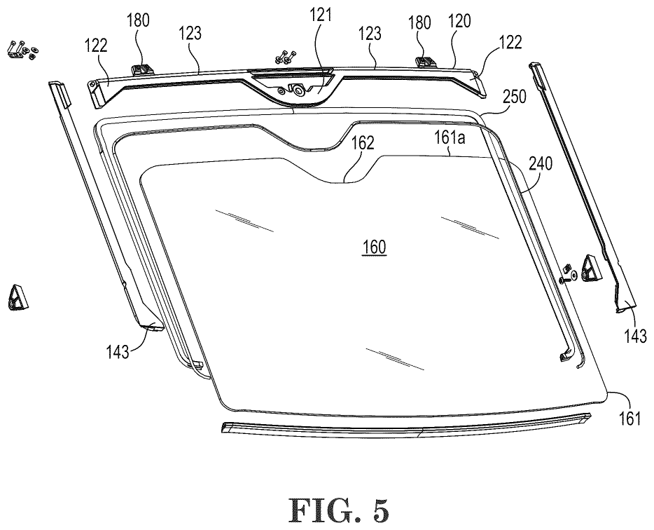

FIGS. 4 and 5 show a second embodiment of a windshield mounting assembly 100, with similar general features described relative to FIGS. 1-3B. As shown in this second embodiment, the edge 161 of windshield 160 has a generally rectangular shape with rounded corners and a generally tapered U-shaped curved portion 162 in the upper edge 161a midway between the side edges of the windshield. The top frame member 120 has a length that is less than the width of the front pillars of the ROPS, but greater than the width of the windshield 160. The top frame member 120 has a width that varies along the length, with a central portion 121, opposite end portions 122 and intermediate portions 123 between the end portions 122 and the central portion 121. The intermediate portions are relatively narrow in relation to the central portion 121 and the end portions 123. The central portion 121 of top frame member 120 is wider than the intermediate portions and has a shape that is complimentary to the curved edge portion 162 of windshield 160. The central portion 121 is configured to mount a windshield wiper motor and related windshield wiper for the windshield. The width of end portions 122 increases gradually from the respective intermediate portions 123 to the respective ends of the top frame member 120. Top frame member 120 defines a channel between the front surface and rear surface along the length of the top frame member 120. A trim piece 240 made of soft foam cord stock is provided to surround the top, side, and lower corner edge portions of the windshield. The foam chord centers the windscreen in the assembly and also absorbs the movement and tolerance variations imparted by the ROPS. A top portion of trim piece 240 friction fits in the channel of top frame member 120. The channel of the top frame member 120 is sized and shaped to receive a top portion of the trim piece before receiving the top edge 161 and top corner edges of the windshield 160.

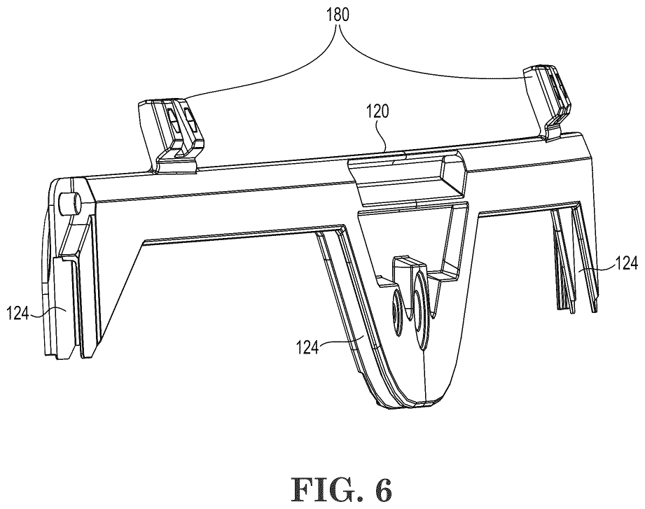

FIG. 6 shows a front perspective view of the top frame member 120 and the channel 124 that extends along the length of the top frame member. The channel 124 has a width that is in close tolerance with the width of the windshield to allow contact between the respective surfaces, yet allow movement of the windshield within the channel. The channel 124 has a depth, i.e., a width, sufficient to overlap the respective edge portions of the windshield to secure the windshield to the ROPS.

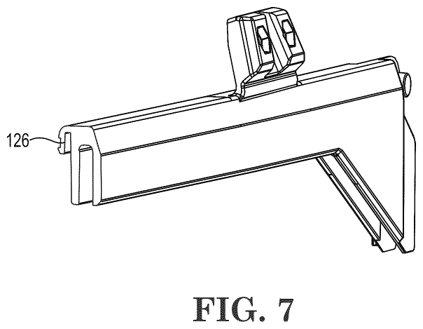

As shown in FIG. 7, which shows a cross-sectional view of the top frame member 120 through the intermediate frame portion 123, a short, generally U-shaped wall 126 extends rearwardly and downwardly from a top rear surface of the top frame member 120 along the length of the top frame member 120. The U-shaped wall 126 forms a groove or clip for attaching a trim piece 250 (shown in FIG. 5) and also functions to form a seal relative to the ROPS. In one embodiment, the U-shaped wall 126 is integrally formed relative to the top frame member 120.

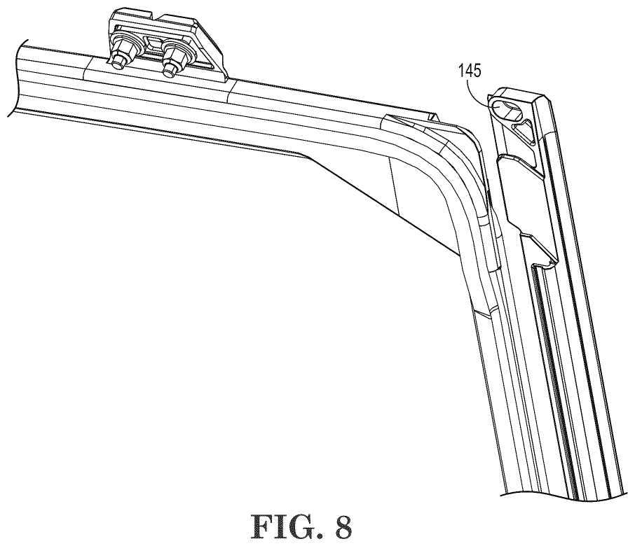

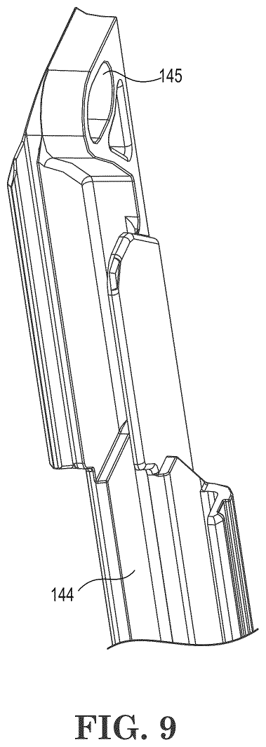

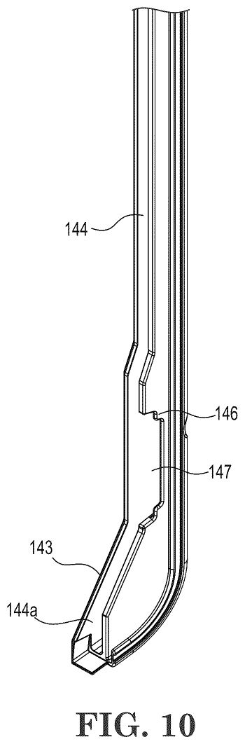

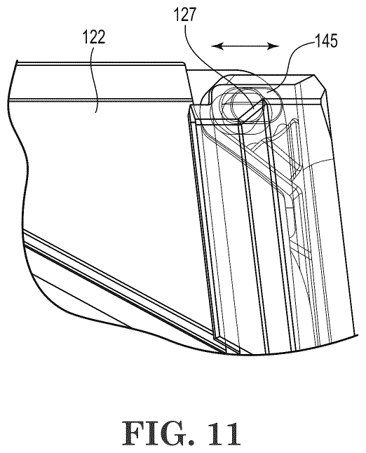

Referring again to FIGS. 4 and 5, side frame members 140 have a length that extends from a top end 141, which connects to the top frame member 120, to a bottom end 142. Side frame members have a width along the length of the side frame members 140. At the bottom end 142, the width of the side frame members 140 gradually increases to form a transverse extension 143. The side frame members 140 each include a channel 144 (FIGS. 9 and 10) along an inside edge that extends along the length and curves to form a lateral channel 144a in the transverse extension 143 (FIG. 10). The channels 144 of side frame members 140 are sized to receive the rest of the trim piece 240 and the side and bottom corner edges of the windshield 160. The top end 141 of each side frame member 140 reversibly attaches to the respective end frame portions 122 of the top frame member 120. As shown in FIGS. 8, 9 and 11, unlike the lift off hinge of the first embedment, in this second embodiment, the top rear surface of each side frame member 140 that faces towards a front surface of the top frame member 120 is formed with a racetrack shaped cavity 145, and the end frame portion 122 of the top frame member 120 is formed with a cylindrical post 127. The cavity 145 has a length that is greater than a width of post 127 and is sized to receive the post 127 yet allow lateral movement of the side frame member relative to the top frame member to allow the side frame members to adjust for tolerance variations of the ROPS.

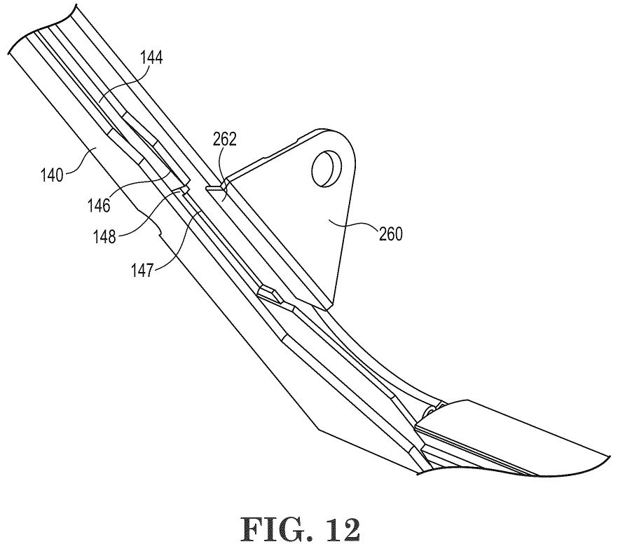

As shown in FIGS. 10 and 12, the inner wall 146 of the side frame members 140 that defines the channel 144 is modified adjacent to the transverse extension 143 of the side frame member to create a mounting site 147 for the removable mount 260. A portion of the inner wall 146 is removed and the thickness of the remaining inner wall is reduced to accommodate a flange 262 of the removable mount 260 that secures side frame members 140 to the ROPS pillars. Flange 262 captures the inner wall 146 and is flush with the inner surface of the inner wall 146. The mount 260 is attached to the pillar of the ROPS to secure the side frame members 140 to the pillar.

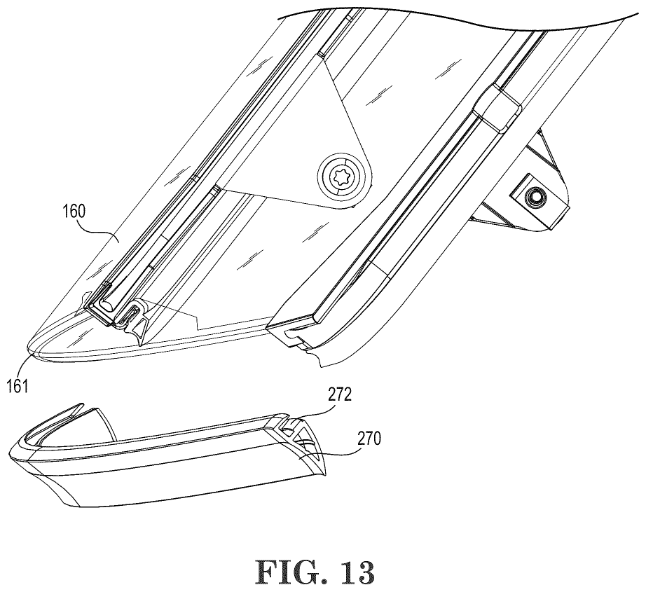

FIG. 13 shows a partially exploded bottom perspective view of the windshield mounting assembly with a bottom windshield trim piece 270 separated from the windshield 160. The bottom windshield trim piece 270 is made from a plastic (e.g., glass filled Nylon, polypropylene, abs, polyethylene, or acrylonitrile styrene acrylate (ASA)) and includes a mounting groove 272 that is positioned over the windshield bottom edge 161 to secure the trim piece to the windshield. The trim piece may be secured to the bottom edge of the windshield with an adhesive.

It is to be understood that the features of the various exemplary embodiments described herein may be combined with each other, unless specifically noted otherwise.

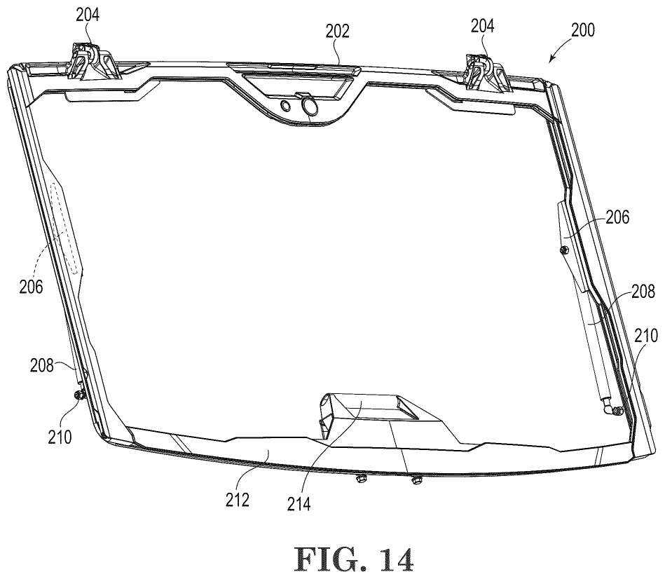

FIG. 14 shows a first embodiment of a pivotable windshield mounting frame and latching system 200 that allows a windshield to be moved between a closed position and a partially open position to allow airflow into the cab of the UTV. As shown in FIG. 14, the top and side frame members are similar to windshield mounting assembly 10 and 100 described above. Unlike those embodiments, the top frame member 202 is connectable to a front transverse beam of the ROPS by a pair of pivotal hinges 204, which allow the side frame members of the windshield frame to move from a first position in contact with the pillars of the ROPS to a second position away from the respective front pillars of the ROPS. In one embodiment, attached to each side frame member via a mounting bracket 206 is a first end of a telescoping strut 208. Each telescoping strut 208 has a second end 210 that is connectable to the respective front pillar of the ROPS. In one embodiment, each telescoping strut is a gas-filled strut that stabilizes the windshield frame assembly on each side of the assembly when the windshield frame assembly is in the second position.

As further shown in FIGS. 14 and 23, attached between the side frame members at the lower end of the side frame members is a bottom frame member 212. In one embodiment, bottom frame member 212 is made from the same materials as described above for frame members 12 and 14. Like the top and side frame members, the bottom frame member 212 has a channel 213 for receiving a bottom edge of a windshield. (See FIG. 23). In one embodiment, attached to the inside surface of the bottom frame member 212 is a windshield handle 214 to facilitate an occupant of the UTV to move the windshield between the first and second position. In one embodiment, windshield handle 214 is made from the same material as bottom frame member 212 and is integrally formed with bottom frame member 212. In an alternative embodiment windshield handle 214 is made from a polycarbonate material.

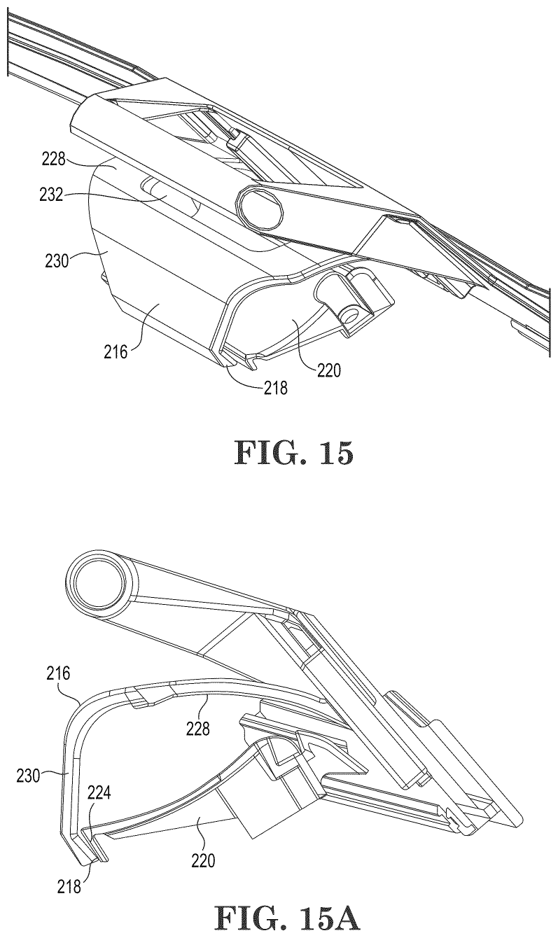

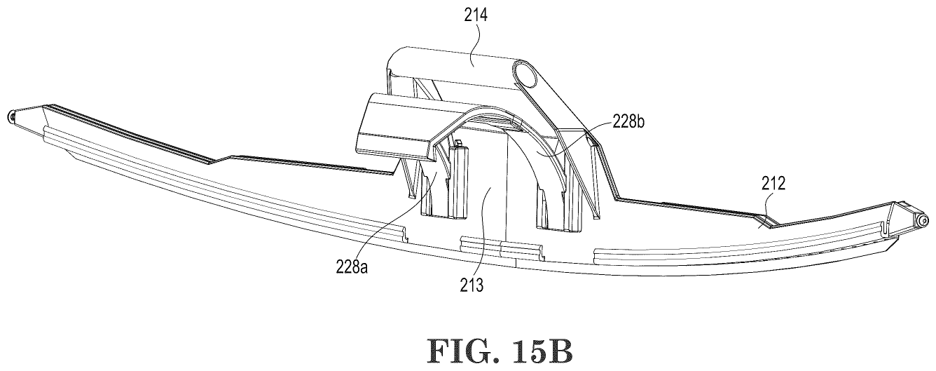

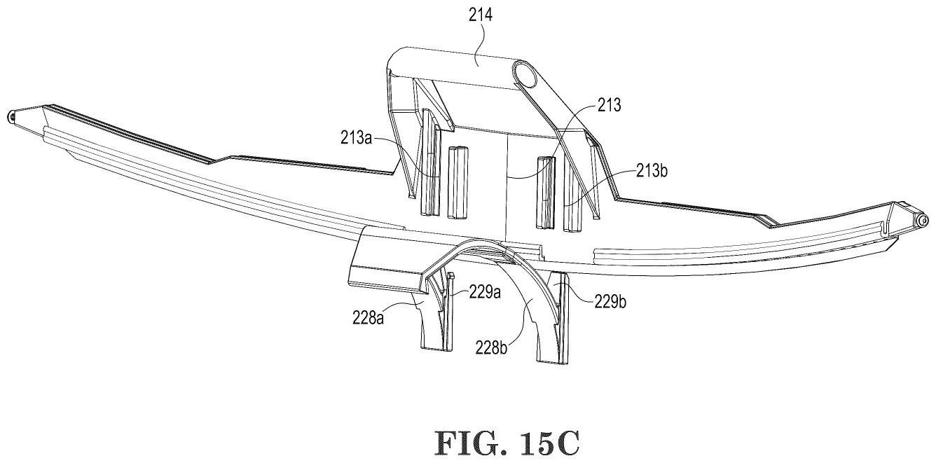

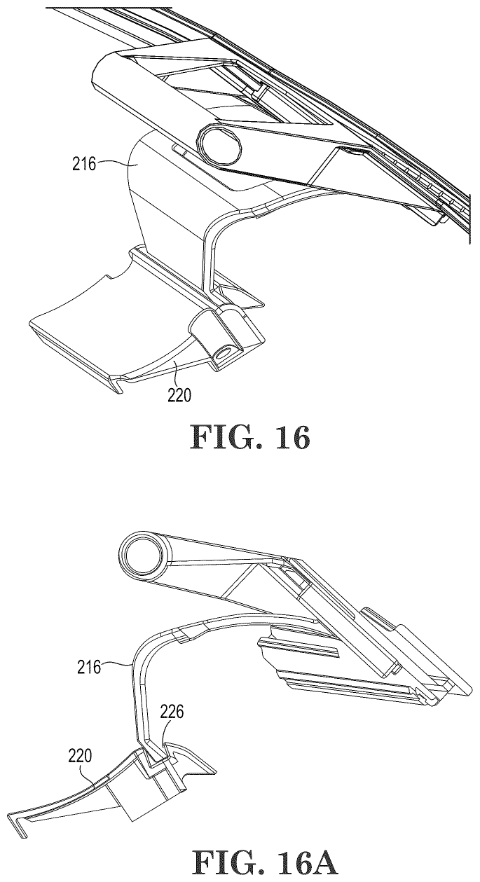

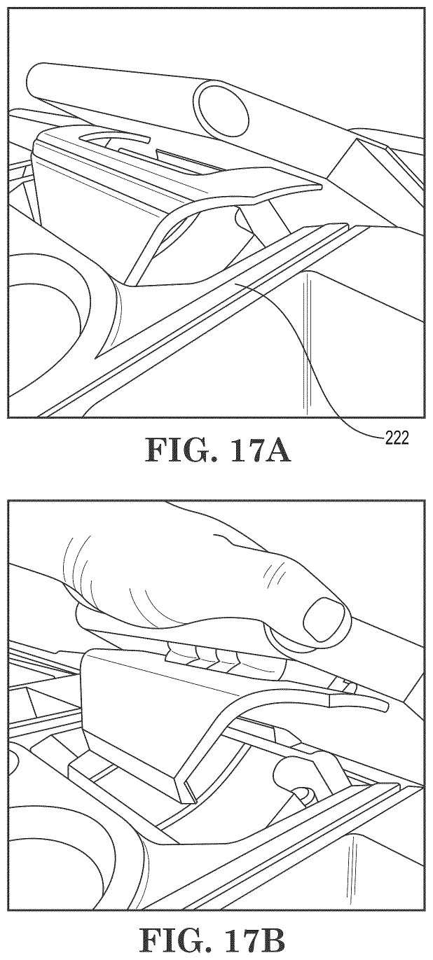

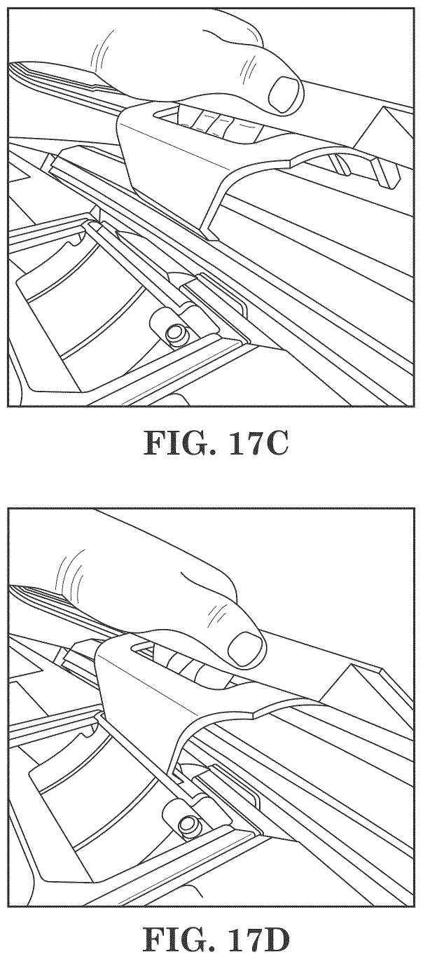

As shown in FIGS. 15, 15A, 16, and 16A, attached to the bottom frame member 212 is a latch 216 that has a free end 218 that extends rearwardly from the bottom frame member 212. The free end 218 is able to engage a dash mount 220 mounted on the UTV dashboard 222 (FIG. 17A) adjacent to the windshield. In one embodiment, the free end of the latch engages the dash mount at two spaced locations: an end surface 224 of the dash mount 220 corresponding to the first position (FIG. 15, 15A) and a groove 226 of the dash mount 220 that is spaced forward of the dash mount end surface 224, which corresponds to the second position (FIG. 16, 16A) of the windshield. In one embodiment, the latch is formed from a curved planar flexible polycarbonate plastic having a first portion 228 connected to the bottom frame member 212 and a second portion 230 that extends from the first portion 228 to the free end 218 of the latch. The first portion 228 curves upward from the handle and second portion 230 curves downward from the first portion 228 to the free end 218 of the latch. The latch is positioned to bias the free end 218 against the dash mount 220.

As shown in FIGS. 15B and 15C, in one embodiment the first portion 228 of latch 216 is comprised of first and second spaced legs 228a and 228b, respectively, each of which is connected to a mounting tab 229a, 229b, respectively, for connecting the latch to an inside surface of the bottom frame member 212. A central portion 213 of the bottom frame member 212 includes spaced channels 213a, 213b that are sized to receive mounting tabs 229a and 229b, respectively. In one embodiment, mounting tabs 229a, 229b are mechanically retained with channels 213a, 213b. In an alternative embodiment, the first and second spaced legs 228a, 228b are integrally formed with the central portion 213 of the bottom frame member 212. The first portion 228 of the latch is configured with an opening 232 (e.g., between legs 228a and 228b), which serves as a handle to allow the latch to be disengaged manually from the first position and moved to the second position, and vice versa. When the windshield is in the first position, the latch engages the end surface of the dash mount to maintain the windshield in the first position. The groove of the dash mount is spaced forward of the end surface 224. To move the windshield to the second position, the latch is manually lifted via the latch opening/handle 232, which allows the latch to flex relative to legs 228a, 228b and disengage the free end 218 from the end surface 224. In an exemplary embodiment, using the windshield handle, the windshield is then moved to the second position. Because the latch is biased toward the dash mount, when the windshield reaches the second position, the latch engages the groove to secure the windshield in the second position. FIGS. 17A-17D.

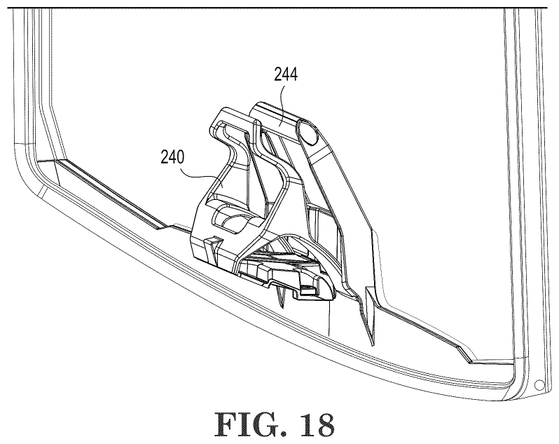

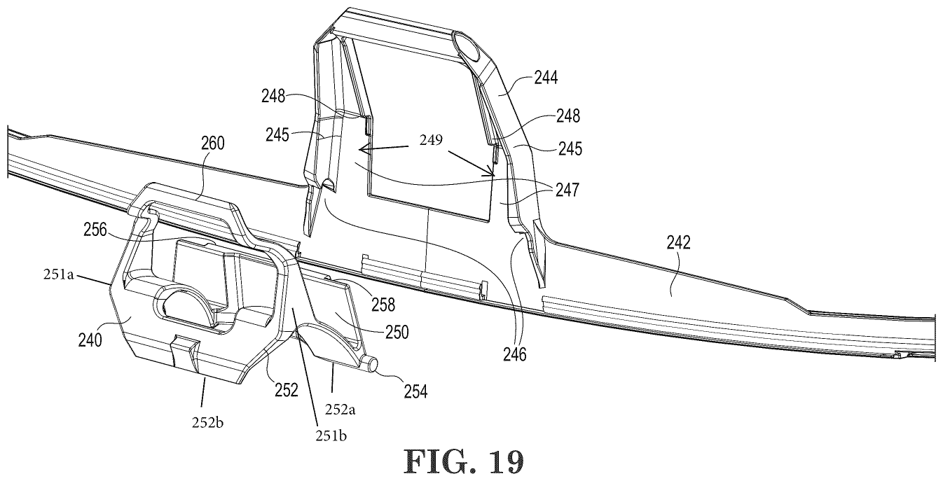

FIG. 18 is a partial rear perspective view of a windshield frame assembly showing a second embodiment of a latch 240 for a UTV windshield frame assembly mounted relative to a windshield handle 244. FIG. 19 shows the bottom frame member 242 and windshield handle 244 in more detail. In one embodiment, windshield handle 244 is integrally formed with bottom frame member 242. Windshield handle 244 includes spaced first and second legs 245. Each leg 245 includes a downward facing curved recess 246 at the base of the leg to form one point of connection for the latch 240. A lower portion 249 of each leg also defines rearward facing surfaces 247 which in the embodiment shown are integral with the bottom frame member 242. The corresponding forward-facing surfaces of the lower leg portions 249 contact the windshield (not shown). Above the rearward facing surfaces on each side, the leg is formed with a rib that extends rearwardly and defines a downward facing bearing surface 247, which serves as another point of connection for the latch. In an alternative embodiment, the windshield handle can be omitted and the legs 245 can be incorporated into the bottom frame member.

The latch 240 generally comprises a mounting plate 250 and a curved planar plastic body 252 that has a first end 252a attached to the mounting plate 250 and a second free end 252b opposite the mounting plate 250. The mounting plate and latch body have a width from the first side 251a to the second side 251b of the latch 240. The curved plastic body of latch 240 is similar in design and function as latch 216. An axle 254 is formed at the point of connection of the mounting plate 250 and the first end 252a of the latch body 252 on each side of the latch 240. The axles 254 extend beyond the width of the mounting plate and latch body. The frontward facing surface of the mounting plate faces towards the rear surface of the bottom frame member and the rearward facing surfaces 247 of the legs of the handle. The frontward facing surface of the mounting plate 250 is stepped with a central portion 256 defining a greater wall thickness than the end portions 258 of the mounting plate.

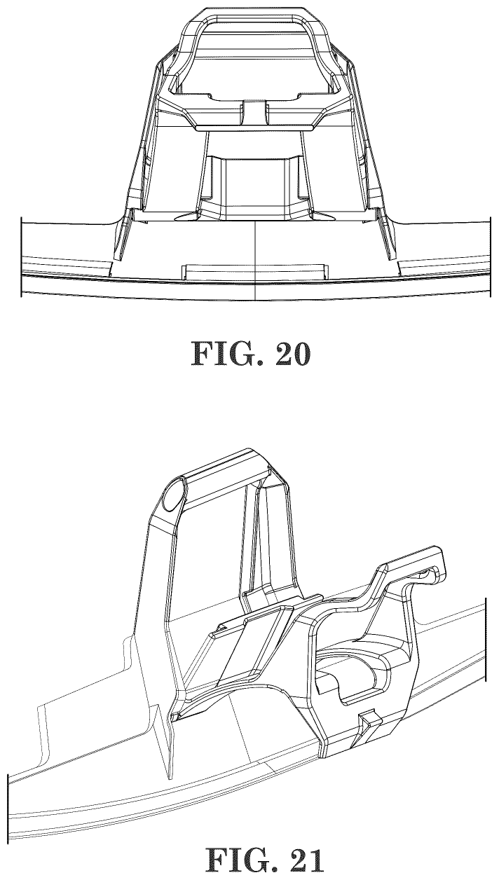

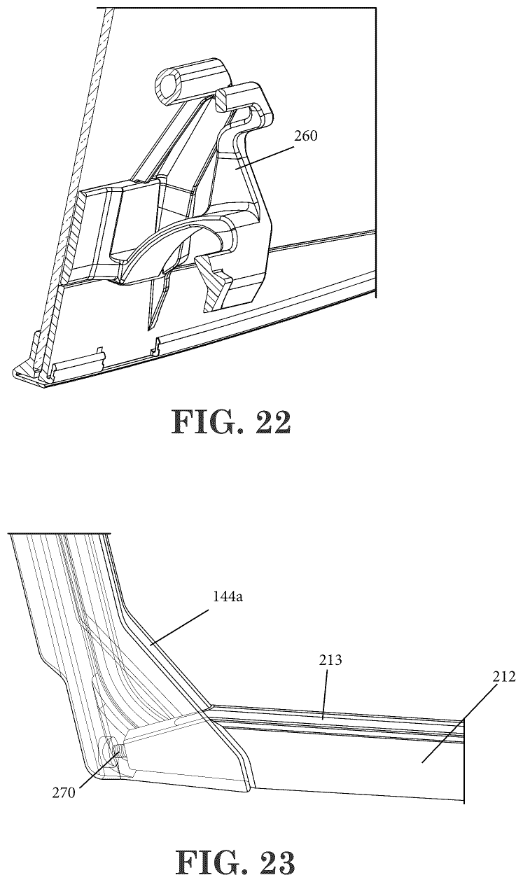

As shown in FIGS. 20-22, the latch is connected to the windshield handle by inserting the axles into the curved recesses 246 of the legs 245. In one embodiment, an adhesive is applied to the frontward facing surface of the mounting plate 250. The mounting plate 250 of the latch is then secured to the handle and windshield by rotating the mounting plate towards the windshield until the adhesive contacts the rearward facing surfaces 247 of the legs and the central portion 256 contacts the windshield. In one embodiment, a latch handle 260 is connected to the latch body at the transition between the first and second portions of the latch body and extends upward from the latch body. The latch handle functions as a lever to flex the latch when the latch handle is moved toward the windshield handle to disengage the latch and move it to and from the first and second positions on the dash mount.

FIG. 23 shows an example of the bottom frame member 212 connection to the side frame members. The ends of the bottom frame member are sized to fit within the lateral channels 144a of the side frame members. Channel 213 in bottom frame member 212 aligns with lateral channels 144a to receive a bottom edge of the windshield. A mechanical connector 270, such as a screw, secures the ends of the bottom frame member 212 to the side frame members.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A windshield mounting assembly for mounting a windshield to roll-over protection frame of a utility terrain vehicle (UTV), the windshield mounting assembly comprising:
a windshield having top, side and bottom edges, the windshield being mounted in a frame having top, side and bottom frame members, the top frame member being pivotally connectable to a top portion of the roll-over protection frame of the UTV, the windshield being moveable between a closed first position and an open second position;
a mount attached to a dashboard of the UTV adjacent to the bottom frame member;
a latch having a first end connected to the bottom frame member and a second end spaced from the bottom frame member, the first end of the latch biased towards the mount, the first end of the latch being engageable with a first position on the mount when the windshield is in the closed first position, and the first end of the latch being engageable with a second position on the mount when the windshield is in the open second position.

2. The windshield mounting assembly of claim 1, wherein the latch comprises a first portion and a second portion connected to the first portion, the first portion extending from the first end to the second portion, the second portion extending from the first portion to the second end, the second portion being at an angle relative to the first portion.

3. The windshield mounting assembly of claim 2, wherein the latch is formed from a curved planar flexible polymer.

4. The windshield mounting assembly of claim 3, wherein the polymer is a polycarbonate plastic.

5. The windshield mounting assembly of claim 2, wherein the first portion comprises first and second spaced legs, the first portion configured to define an opening between the first and second legs.

6. The windshield mounting assembly of claim 3, wherein the second portion of the latch is able to flex relative to the first portion of the latch and away from the mount to move between the first and second positions.

7. The windshield mounting assembly of claim 5, wherein the first and second legs are mechanically connected to the bottom frame member.

8. The windshield assembly of claim 5, wherein the first and second legs are integrally connected to the bottom frame member.

9. The windshield assembly of claim 2 and further including a latch handle connected to the latch body at a transition between the first portion and the second portion, the latch handle extending upward from the latch body.
